(19) United States
(12) Patent Application Publication
(10) Pub. No.: US 2011/0240630 A1
(43) Pub. Date: Oct. 6, 2011

(54) Heater for a vehicular fluid tank, motor vehicle comprising same, and method for heating a vehicular fluid tank

(75) Inventors: Laurent ETORRE, Schaerbeek (BE); Florent BARZIC, Munich (DE); François-Régis LAVENIER, Jette (BE); Volodia NAYDENOV, Louvain-la-Neuve (BE); Guillaume ZELLER, Brussels (BE); Ignacio GARCIA-LORENZANA, Frankfurt Am Main (DE)

(73) Assignee: INERGY AUTOMOTIVE SYSTEMS RESEARCH (Societe Anonyme), Brussels (BE)

(21) Appl. No.: 13/078,763

(22) Filed: Apr. 1, 2011

(30) Foreign Application Priority Data
Apr. 6, 2010 (EP) 10159125.3

(51) Int. Cl. H05B 3/02

(52) U.S. Cl. 219/482

(57) ABSTRACT

A heating system for a vehicular fluid tank (100), said heating system comprising at least one resistive element (110) and a control unit (120) adapted to direct an electric current through said at least one resistive element (110), wherein said control unit (120) is adapted to vary said current according to a pulse width modulation scheme.

### CROSS-REFERENCE TO RELATED APPLICATIONS

This application claims priority to European Application N^{o} 10159125.3 filed on Apr. 6, 2010, the whole content of this application being incorporated herein by reference for all purposes.

### TECHNICAL FIELD OF THE INVENTION

The present invention pertains to a heating system for a vehicular fluid tank, said heating system comprising at least one resistive element and a control unit adapted to direct an electric current through said at least one resistive element. The present invention also pertains to a motor vehicle comprising such a heating system. The present invention also pertains to a method for heating a vehicular fluid tank.

### BACKGROUND OF THE INVENTION

Heating systems for vehicular fluid tanks, in particular for tanks intended to hold liquids which can freeze at normal winter temperatures, such as ammonia precursor solutions used in selective catalytic reduction reactions (SCR) to treat exhaust gas from internal combustion engines, are known in the art. A commonly used type of precursor solution is a eutectic liquid mixture of water and urea, which is commercially available under the trademark AdBlue. This solution is known to freeze at temperatures below approximately −11° C., a condition which regularly occurs during winter time in many areas of the world. Hence, it is necessary under these conditions to thaw a quantity of the stored solution before the reduction of the NOx compounds in the exhaust gas can start taking place.

Patent application WO 2008/138960 A1 in the name of applicant describes a urea tank and base plate with an integrated heating element. The integrated heating element comprises at least one flexible heating part. Preferably, the flexible part is a flexible heater, that is to say that it comprises at least one resistive track inserted between two flexible films or affixed to a flexible film.

In the heating systems described above, it is important to avoid overheating of the ammonia precursor solution, which could lead to unpleasant odors and even to undesirable alterations of the properties of the solution. The prior-art solution to this problem is to use heating elements with a resistance that has a positive temperature coefficient (PTC), thus providing a certain amount of self-regulation. However, when the PTC is warm, less heating power is available. Besides, since the current consumption varies with temperature, a diagnosis of the heater based on the plausibility of the current consumption is difficult.

In typical automotive situations, the power supply voltage can range between 9 and 16 Volt, depending on the overall instantaneous load on the electrical system. The supply voltage fluctuates as various electrical functions switch on and off, as a result of actions by the vehicle operator or instructions from the vehicle electronics. Typically, these electrical functions are a mix of high-consumption functions such as an air conditioning unit and a rear window defroster, and low-consumption unit such as various electronic circuits and indicators. These functions may cycle through on and off status at very diverse timescales. As a result, the amount of heat dissipated by the resistive element will also fluctuate, making it difficult to control the precise conditions under which the content of the vehicular fluid tank will be thawed and/or heated.

The controllability of the heating conditions is a serious concern for SCR systems, because vehicle manufacturers want to ensure a sufficiently rapid thawing process to comply with applicable emission standards, in particular with respect to NOx emissions, while avoiding overheating of the ammonia precursor solution. It is a further concern to avoid overheating of the heating system itself, including for example the control unit, the fluid container, the wiring and the resistive elements.

### SUMMARY OF THE INVENTION

It is an object of the present invention to provide a heating system of the kind described above that meets the above concerns.

According to an aspect of the invention, there is thus provided a heating system as described, wherein the control unit is adapted to vary said current according to a pulse width modulation scheme.

The invention is based on the insight that by varying the duty cycle of the pulse width modulated current, the amount of heat dissipated by the resistive element varies in the same degree.

Hence, the heating system can advantageously be dimensioned to operate according to a desired characteristic at the lowest supply voltage that can normally be expected, and the duty cycle of the pulse width modulated current can then be modulated to compensate when the actual supply voltage is higher than this minimum.

The use of pulse width modulation to control a heater is known in the art. US patent application 2004/0170212 A1 discloses the use of pulse width modulation to control the average effective current directed through a resistance heater. The heater disclosed therein is intended for heating a sensor and does not have the required characteristics for use with a vehicular fluid tank.

It is a further object of embodiments of the present invention to allow for a staged thawing process, in which a first stage operates at a higher level of heat dissipation, as required to rapidly thaw a sufficient quantity of solution to allow a pump to start operating, and a second stage operates at a lower level of heat dissipation, to allow a gradual thawing of the remainder of the tank contents.

In an embodiment of the heating system of the present invention, the pulse width modulation scheme is applied so that at least two distinct heating power levels can be obtained.

This embodiment has the advantage of allowing a staged thawing process. The respective desired characteristics are obtained by applying a further modification to the duty cycle.

In an embodiment of the heating system of the present invention, the control unit is adapted to determine the duty cycle in inverse proportion to the square a smoothened measurement of the supply voltage.

Use of a smoothened measurement has the advantage that high-frequency fluctuations of the supply voltage are ignored. This can be done without negatively impacting the operation of the heating system, because the thermal inertia of the resistive element and its surroundings will normally be sufficiently large to make very fine-grained modulation thermally undetectable.

In an embodiment, the heating system further comprises a temperature sensor operatively coupled to said control unit, wherein said control unit is adapted to modify a duty cycle of said current in response to a temperature reading received from said temperature sensor.

This embodiment has the advantage of being able to provide an additional protection against overheating of selected parts of the vehicular tank system. In a particular embodiment, the temperature sensor is placed in or near the control unit. This embodiment has the advantage of protecting the control unit, which may be implemented with temperature-sensitive electronics. In another particular embodiment, the temperature sensor is placed near the resistive element. This embodiment has the advantage of providing a real feedback loop, such that the system can operate like a thermostat in addition to the control features described above.

According to an aspect of the invention, there is provided a motor vehicle comprising a fluid tank equipped with the heating system of the invention.

According to another aspect of the invention, there is provided a method for heating a vehicular fluid tank with at least one resistive element receiving an electric current from a power supply under the control of a control unit (120), the method comprising varying said current according to a pulse width modulation scheme.

In an embodiment of the method of the present invention, the pulse width modulation scheme is applied in such a way that at least two distinct heating power levels can be obtained.

In an embodiment, the method of the present invention further comprises measuring a voltage of said power supply, smoothening said supply voltage, and determining a duty cycle for said pulse width modulation in inverse proportion to the square of said smoothened supply voltage.

In an embodiment, the method of the present invention further comprises measuring a temperature, and modifying a duty cycle of said current in response to said temperature. In a particular embodiment, said temperature is measured in or near said control unit (120). In a particular embodiment, said temperature is measured near said resistive element (110).

### BRIEF DESCRIPTION OF THE DRAWINGS

These and other aspects of the invention will be better understood by reference to the following figures, in which:

FIG. 1 is a schematic representation of the heating system of the present invention;

FIG. 2 is a diagram of the relative pulse width in function of the supply voltage in a heating system according to the present invention; and

FIG. 3 is a flow chart of an embodiment of the method according to the present invention.

### DETAILED DESCRIPTION OF PREFERRED EMBODIMENTS

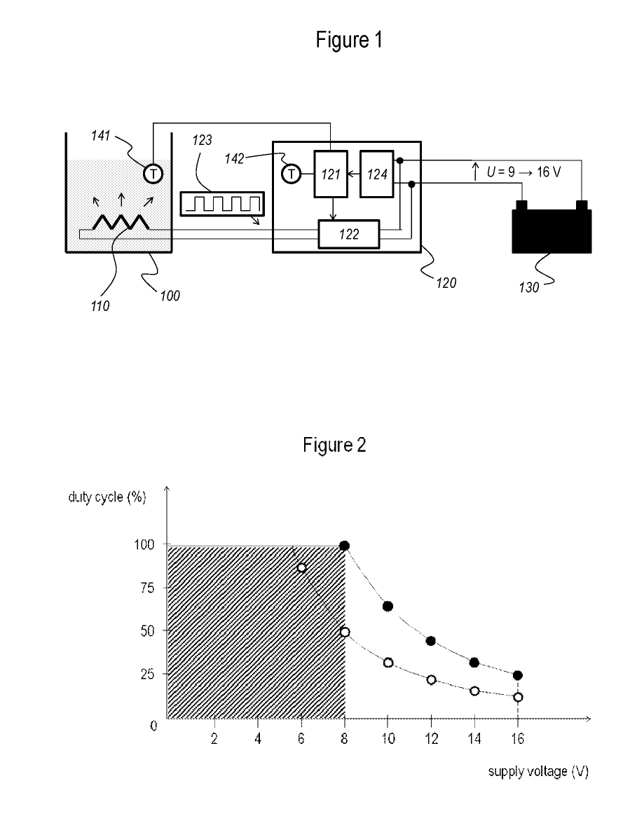

The embodiment schematically depicted in FIG. 1 comprises a resistive element 110 inside a vehicular fluid tank 100, in particular tank for holding a urea solution, whereby the resistive element 110 is used to heat the content of the tank 100. In particular embodiments of the system of the present invention, resistive elements may also or instead be arranged outside and near the tank, or at accessories of the tank which require expedited thawing of the surrounding solution, such as a urea solution pump.

The resistive element 110 receives a current from a control unit 120, which draws its energy from a power supply, here depicted as a battery 130. The skilled person shall understand that although only a battery 130 is shown, other power supply elements such as an alternator may be present in addition to or as an alternative to the battery 130.

The skilled person will also appreciate that wherever in this description the control unit 120 is described as delivering, directing, or controlling a current, this action may in fact be accomplished by acting accordingly on the voltage of the corresponding electrical signal, the two variables being intrinsically linked by the overall resistance of the circuit through which the electrical energy is led.

Control unit 120 is adapted to convert the power supply voltage provided by battery 130, which may fluctuate between approximately 9 V and approximately 16 V, into a pulse width modulated electrical signal, schematically illustrated as block wave 123. The energy in this signal is converted to heat by the resistive element 110.

To this end, the control unit 120 comprises a duty cycle calculating agent 121 and a switching agent 122.

The duty cycle calculating agent 121 combines all relevant information to determine the desired duty cycle according to the present inventive concept. Thus, the duty cycle calculating agent 121 is adapted to determine the required duty cycle for a desired level of heat dissipation, taking into account the instantaneous supply voltage level delivered by the battery 130, as described in more detail with reference to FIG. 2 below. Preferably, the duty cycle calculating agent 121 is adapted to determine the respective required duty cycles for a first and a second desired level of heat dissipation, taking into account the instantaneous supply voltage level. The duty cycle calculating agent 121 measures the supply voltage directly, or indirectly after the operation of smoothener 124, which is intended to remove high-frequency fluctuations from the measured supply voltage measurement. The smoothener 124 may be implemented as a usual low-pass filter.

The control unit 120, and more particularly the duty cycle calculating agent 121, is operatively coupled to a first temperature sensor 141 arranged near the resistive element 110, preferably in the tank 100, and/or a second temperature sensor 142 arranged in or near said control unit 120. The duty cycle calculating agent 121 can take temperature readings from these temperature sensors 141, 142 into account in the determination of the duty cycle, in order to meet additional objectives, such as avoiding unnecessary heating of the tank 100 when the content is not frozen, avoiding overheating of the content of the tank 100, and avoiding overheating of the control unit 120, the components of which may be temperature-sensitive.

The switching agent 122, operatively coupled to the duty cycle calculating agent 121, is adapted to perform the actual pulse width modulation according to the duty cycle determined by the duty cycle calculating agent 121, thus transforming the voltage supplied by the battery 130 into the desired voltage wave 123.

The duty cycle calculating agent 121 and the switching agent 122 may be implemented, separately or together, using any of the well known technologies for electronic control circuitry, including for example appropriately programmed processors or microcontrollers, appropriately configured programmable logic including field-programmable gate arrays (FGPAs), dedicated integrated circuits (ASICs), and discrete electronic circuits.

FIG. 2 represents the relative pulse width in function of the supply voltage in a heating system according to an embodiment of the present invention. For illustrative purposes, it is assumed that the heating system is adapted to operate at a first heating power level of P₁=100 W and a second heating power level of P₂=50 W. The heating system is designed to provide these power levels at a supply voltage level of Uₘᵢₙ=8 V, which corresponds to slightly less than the lowest normally expected supply voltage in a typical automotive system. As P₂=Uₘᵢₙ²/R for a duty cycle of 100%, i.e. for a heater that is always on, we find that the resistive element has to have a resistance of 0.64Ω.

In order to maintain a first heat dissipation level of 100 W for levels of the supply voltage above the minimum level mentioned above, the duty cycle of the pulse width modulated heating current is reduced. Thus, as a twofold increase in the supply voltage, i.e. a supply voltage of 16 V, would result in a fourfold increase in heat dissipation under otherwise identical conditions, the corresponding duty cycle has to be set to 25% in order to maintain a 100 W heat dissipation level. The same calculation applies to any intermediate value of the supply voltage, thus leading to the uppermost curve (with data points shown as solid bullets) in the diagram of FIG. 2, in which the resulting duty cycle clearly displays a 1/U² proportionality.

In order to obtain a second heat dissipation level of 50 W at the minimum supply voltage level Uₘᵢₙ mentioned above, the duty cycle of the pulse width modulated heating current is set to 50% at this voltage. To maintain this level of heat dissipation for levels of the supply voltage above the minimum level, the duty cycle is further reduced. Again, as a twofold increase in the supply voltage, i.e. a supply voltage of 16 V, would result in a fourfold increase in heat dissipation under otherwise identical conditions, the corresponding duty cycle has to be set to 12.5% in order to maintain a 50 W heat dissipation level. The same calculation applies to any intermediate value of the supply voltage, thus leading to the lowermost curve (with data points shown as hollow bullets) in the diagram of FIG. 2, in which the resulting duty cycle again clearly displays a 1/U² proportionality.

In FIG. 2, the hashed region representing supply voltage levels between 0 V and 8 V is an anomalous region. It is not possible to determine a duty cycle value between 0% and 100% which would lead to the desired heat dissipation of 100 W if the resistance of the heating element is chosen as indicated above. Using duty cycle values above 50%, it is in principle possible to provide a heating level of 50 W as long as the supply voltage is greater than or equal to U_{50 W}=√(100%×50 W×0.64Ω)=5.66 V.

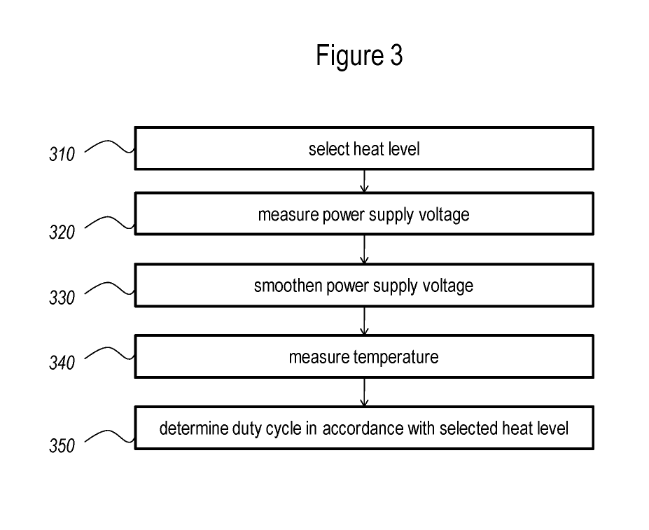

FIG. 3 represents a flow chart of an embodiment of the method of the present invention.

In step 310, a desired heat level is selected from at least a first and a second desired level of heat dissipation. This may happen according to a predetermined time-schedule, for instance in order to apply a higher heat dissipation level during a predetermined time T₁ immediately after the engine start, and a lower heat dissipation level after the expiry of time T₁. In step 320, the instantaneous power supply voltage is measured. The supply voltage is optionally smoothened at step 330.

The order of steps 320 and 330 may vary between embodiments. The supply voltage may be measured as it is, whereupon a numerical smoothening algorithm, such as a time averaging algorithm, is applied to the measurement values. Alternatively, the supply voltage may be passed through a low-pass filter or other electronic smoothening means, whereupon the smoothened signal is measured for further use by the control unit. Measurement and smoothening may also be combined, for instance by using a low-frequency sample-and-hold measurement method.

Optionally, one or more temperature values are obtained by measurement, preferably by temperature sensors positioned as described above for sensors 140 and 141 of FIG. 1.

Finally, in step 350, all the relevant information is combined to determine the desired duty cycle according to the present inventive concept. Thus, the control unit 120 determines the required duty cycle for one of at least a first and a second desired level of heat dissipation, taking into account the instantaneous supply voltage level delivered by the battery 130, as described in more detail with reference to FIG. 2 above. Temperature measurements, if available, are taken into account so as to further reduce the duty cycle (or even shut down the heating system completely, which corresponds to a duty cycle of 0%), for instance when the measurement of the temperature indicates a risk of overheating of the tank contents and/or the control unit.

Although the method of the present invention has been described and illustrated as a series of consecutive steps, the skilled person will appreciate that the order of these steps is generally not material to the invention.

Although the invention has been described herein with reference to certain exemplary embodiments, the skilled person will understand that these embodiments serve to illustrate and not to limit the invention, the full scope of which is determined by the enclosed claims.

1. A heating system for a vehicular fluid tank (100), said heating system comprising at least one resistive element (110) and a control unit (120) adapted to direct an electric current through said at least one resistive element (110), wherein said control unit (120) is adapted to vary said current according to a pulse width modulation scheme.

2. The heating system of claim 1, wherein the pulse width modulation scheme is applied so that at least two distinct heating power levels can be obtained.

3. The heating system of claim 1, wherein the control unit (120) is adapted to determine a duty cycle of said current in inverse proportion to the square of a smoothened measurement of the supply voltage.

4. The heating system of claim 1, further comprising a temperature sensor (141, 142) operatively coupled to said control unit (120), wherein said control unit (120) is adapted to modify a duty cycle of said current in response to a temperature reading received from said temperature sensor (141, 142).

5. The heating system of claim 4, wherein said temperature sensor (142) is placed in or near said control unit (120).

6. The heating system of claim 4, wherein said temperature sensor (141) is placed near said resistive element (110).

7. A motor vehicle comprising a fluid tank equipped with the heating system of claim 1.

8. The motor vehicle of claim 7, wherein said fluid tank (100) is a tank for storing an additive to be used in a selective catalytic reduction reaction.

9. A method for heating a vehicular fluid tank (100) with at least one resistive element (110) receiving an electric current from a power supply under the control of a control unit (120), said method comprising varying said current according to a pulse width modulation scheme.

10. The method of claim 9, wherein said pulse width modulation scheme is applied in such a way that at least two distinct heating power levels can be obtained.

11. The method of claim 9, further comprising measuring a voltage of said power supply, smoothening said measured supply voltage, and determining a duty cycle for said pulse width modulation in inverse proportion to the square of said smoothened measured supply voltage.

12. The method of claim 9, further comprising measuring a temperature, and modifying a duty cycle of said current in response to said temperature.

13. The method of claim 12, wherein said temperature is measured in or near said control unit (120).

14. The method of claim 12, wherein said temperature is measured near said resistive element (110).
